(19) United States
(12) Patent Application Publication
(10) Pub. No.: US 2018/0003796 A1
(43) Pub. Date: Jan. 4, 2018

(54) MOBILE DEVICE POSITIONING

(71) Applicant: Harman Internation Industries, Incorporated, Stamford, CT (US)

(72) Inventors: Zeng YANG, Shanghai (CN); Zongcheng CHEN, Shanghai (CN); Qingshan ZHANG, Shanghai (CN)

(21) Appl. No.: 15/535,404

(22) PCT Filed: Feb. 11, 2015
(86) PCT No.: PCT/CN2015/072739

§ 371 Date: Jun. 12, 2017

(51) Int. Cl. G01S 5/30; G01S 5/26; G01S 1/80

(52) U.S. Cl. CPC G01S 5/30; G01S 1/80; G01S 5/26

(57) ABSTRACT

A method and a system for generating a plurality of ranging sound signals for positioning a mobile device are provided. The method includes: each of a plurality of ranging signal generating devices, which are connected to an audio signal cable and are located at different positions in an area, generating a ranging sound signal based on a synchronization signal transmitted on the audio signal cable, whereby location of the mobile device within the area can be obtained based on records of the ranging sound signals made by the mobile device. Accordingly, a plurality of speakers connected in series are able to be controlled to reproduce ranging sound signals for positioning a mobile device.

### TECHNICAL FIELD

The present disclosure generally relates to mobile device positioning.

### BACKGROUND

Usually, a conventional indoor positioning system includes a plurality of speakers each of which is driven by a separate amplifier module, such that the plurality of speakers are able to receive different signals. Therefore, it is relatively easy to control the plurality of speakers to reproduce ranging sound signals at particular time intervals to implement indoor positioning.

However, in many speaker systems, such as broadcasting systems in train stations and airports etc., a plurality of speakers are connected in series and driven by a single amplifier module, which means the plurality of speakers receive the same signal. Controlling the plurality of speakers to reproduce ranging sound signals at particular time intervals is a problem.

### SUMMARY

According to one embodiment, a method for generating a plurality of ranging sound signals for positioning a mobile device is provided. The method may include: each of a plurality of ranging signal generating devices, which are connected to an audio signal cable and are located at different positions in an area, generating a ranging sound signal based on a synchronization signal transmitted on the audio signal cable, whereby location of the mobile device within the area can be obtained based on records of the ranging sound signals made by the mobile device.

In some embodiments, the ranging sound signal is generated after a preset time period from receipt of the synchronization signal by a detecting unit, where the detecting unit is adapted to obtain a receipt time point of the synchronization signal being received by the plurality of ranging signal generating devices.

In some embodiments, the preset time period for each of the plurality of ranging signal generating devices is configured to be different, such that the ranging sound signals are generated at different time points.

In some embodiments, the preset time period for each of the plurality of ranging signal generating devices is configured to be the same, where the ranging sound signals are distinct from each other.

In some embodiments, the synchronization signal is mixed, by a mixing device, with a content audio signal to be transmitted on the audio signal cable, where the content audio signal is for driving a plurality of speakers connected to the audio signal cable to reproduce the content audio signal.

In some embodiments, the method further includes: separating the synchronization signal and the content audio signal from each other, where the synchronization signal is transmitted to the plurality of ranging signal generating devices, and the content audio signal is transmitted to the plurality of speakers.

In some embodiments, the plurality of ranging signal generating devices are respectively connected to the plurality of speakers, such that electric signals from the plurality of ranging signal generating devices are respectively converted into acoustic signals by the plurality of speakers.

In some embodiments, the ranging sound signal is converted from a digital signal to an analog signal before the ranging sound signal is transmitted to one of the plurality of speakers.

In some embodiments, the records of the ranging sound signals include at least one selected from a group consisting of an arrival time of each ranging sound signal, an arrival time difference between each two of the ranging sound signals, and a signal attenuation of each ranging sound signal.

According to one embodiment of the present disclosure, a system for generating a plurality of ranging sound signals for positioning a mobile device is provided, including: a plurality of ranging signal generating devices which are connected to an audio signal cable and are located at different positions in an area, wherein each of the plurality of ranging signal generating devices is configured to: generate a ranging sound signal based on a synchronization signal transmitted on the audio signal cable, whereby location of the mobile device within the area can be obtained based on records of the ranging sound signals made by the mobile device.

In some embodiments, the plurality of ranging signal generating devices are respectively connected to the plurality of speakers, such that electric signals from the plurality of ranging signal generating devices are respectively converted into acoustic signals by the plurality of speakers.

In some embodiments, the system further includes a detecting unit adapted to detect the receipt of the synchronization signal, where the detecting unit is adapted to obtain a receipt time point of the synchronization signal being received by the plurality of ranging signal generating devices.

In some embodiments, the ranging sound signal is generated after a preset time period from receipt of the synchronization signal.

In some embodiments, the preset time period for each of the plurality of ranging signal generating devices is configured to be different, such that the ranging sound signals are generated at different time points.

In some embodiments, the preset time period for each of the plurality of ranging signal generating devices is configured to be the same, where the ranging sound signals are distinct from each other.

In some embodiments, the system further includes a mixing device for mixing the synchronization signal with a content audio signal before the mixed signal is transmitted on the audio signal cable, where the content audio signal is for driving a plurality of speakers connected to the audio signal cable to reproduce the content audio signal.

In some embodiments, the system further includes a separating unit for separating the synchronization signal and the content audio signal from each other, where the synchronization signal is transmitted to the plurality of ranging signal generating devices, and the content audio signal is transmitted to the plurality of speakers.

In some embodiments, the system further includes a digital to analog converter adapted to convert the ranging sound signal from a digital signal to an analog signal before the ranging sound signal is transmitted to one of the plurality of speakers.

In some embodiments, the records of the ranging sound signals include at least one selected from a group consisting of an arrival time of each ranging sound signal, an arrival time difference between each two of the ranging sound signals, and a signal attenuation of each ranging sound signal.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 schematically illustrates a speaker system for positioning a mobile device within an area;

FIG. 2 schematically illustrates a flow chart for generating a plurality of ranging sound signals for positioning a mobile device; and

FIG. 3 schematically illustrates a ranging signal generating device for generating a ranging sound signal at a preset time point.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

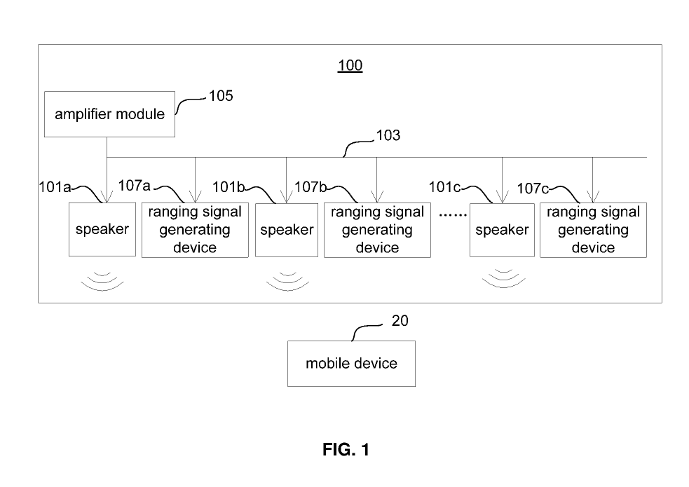

FIG. 1 schematically illustrates a speaker system 100 for positioning a mobile device 20 in an area.

The speaker system 100 includes a plurality of speakers 101a, 101b and 101c, which are connected in series and located on different points along an audio signal cable 103. The plurality of speakers 101a, 101b and 101c are driven by a single amplifier module 105 to reproduce a content audio signal transmitted on the audio signal cable 103. It should be noted that numbers and arrangement of the speakers and the ranging signal generating devices in FIG. 1 are just for illustration. In some embodiments, the number of the speakers and the ranging signal generating devices are both not less than three.

The content audio signal may be signals broadcasted periodically in the train stations or airports. As the content audio signal is transmitted on the audio signal cable 103 really fast, it can be assumed that the plurality of speakers 101a, 101b and 101c receive the content audio signal substantially at a same time point.

The speaker system 100 further includes a plurality of ranging signal generating devices 107a, 107b and 107c which are connected to the audio signal cable 103 and are located at different positions in the area. The plurality of ranging signal generating devices 107a, 107b and 107c are configured to generate a plurality of ranging sound signals. The speakers 101a, 101b and 101c may be configured to broadcast the ranging sound signals respectively, such that the mobile device 20 can receive the plurality of ranging sound signals and make records of them. Based on the records of the ranging sound signals, position relation between the mobile device 20 and each of the speakers 101a, 101b and 101c, location of the mobile device 20 can be obtained.

For positioning the mobile device 20, more specifically, for identifying the arrival of the ranging sound signals in the records, respectively, in some embodiments, the plurality of ranging sound signals may be distinct from each other. Or else, in some embodiments, the plurality of ranging sound signals may be broadcasted at different time points.

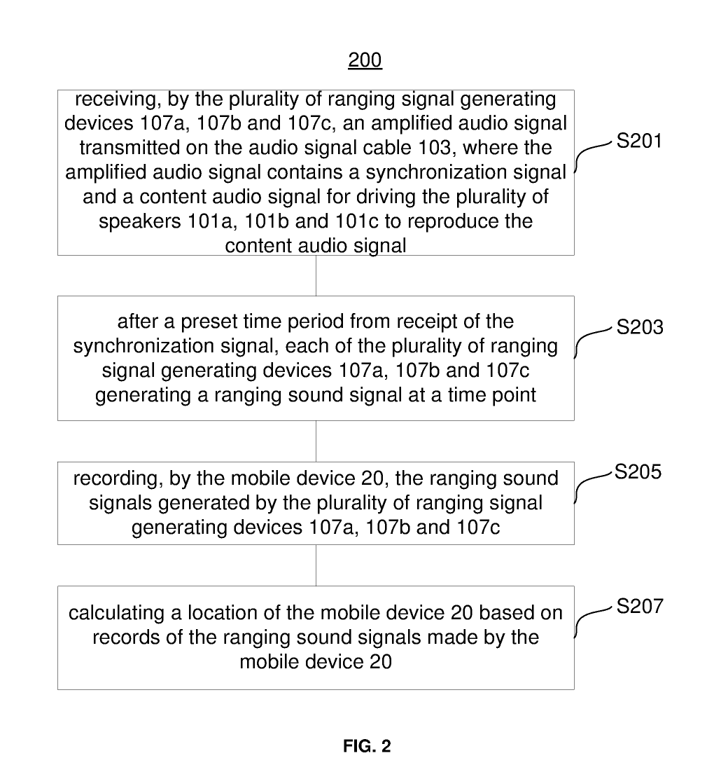

FIG. 2 schematically illustrates a flow chart 200 for generating a plurality of ranging sound signals for positioning the mobile device 20.

With reference to FIG. 1 and FIG. 2, in S201, receiving, by the plurality of ranging signal generating devices 107a, 107b and 107c, an amplified audio signal transmitted on the audio signal cable 103, where the amplified audio signal contains a synchronization signal and a content audio signal for driving the plurality of speakers 101a, 101b and 101c to reproduce the content audio signal.

In some embodiments, the plurality of ranging signal generating devices 107a, 107b and 107c may be connected to the audio signal cable 103 at different points along the audio signal cable 103. In other words, the plurality of ranging signal generating devices 107a, 107b and 107c are connected to the audio signal cable 103 in series.

In some embodiments, the amplified audio signal may be obtained by mixing the synchronization signal with the content audio signal together. In some embodiments, a mixing device may mix the synchronization signal with the content audio signal together. In some embodiments, the mixing device may be a digital mixing device for mixing digital signals together. In some embodiments, the mixing device may be an analog mixing device for mixing analog signals together. The mixed signal may be transmitted to an amplifier module 105 for amplifying it. The plurality of ranging signal generating devices 107a, 107b and 107c may receive the amplified audio signal, containing both the synchronization signal and the content audio signal, from the amplifier module 105.

In some embodiments, the synchronization signal may be a chirp signal and have a frequency higher than a preset value F1, the content audio signal may have a frequency lower than the preset value F1. Therefore, the content audio signal would not be interfered with the synchronization signal. In some embodiments, the preset value F1 may be 19 KHz. In some embodiments, the chirp signal may be an up-chirp signal, a down-chirp signal, or a combination thereof.

In some embodiments, the flow chart 200 may further include: separating the synchronization signal and the content audio signal from each other, where the synchronization signal is transmitted to the plurality of ranging signal generating devices 107a, 107b and 107c, the content audio signal is transmitted to the plurality of speakers 101a, 101b and 101c for driving the plurality of speakers 101a, 101b and 101c to reproduce the content audio signal.

In some embodiments, a separating unit may be employed to separate the synchronization signal from the content audio signal. In some embodiments, the separating unit may include a high-pass filter and low-pass filter. The high-pass filter is able to filter out the content audio signal which has a frequency lower than the preset value F1 and pass the synchronization signal which has a frequency higher than the preset value F1. Similarly, the low-pass filter is able to filter out the synchronization signal which has a frequency higher than the preset value F1 and pass the content audio signal which has a frequency lower than the preset value F1. Thereafter, the synchronization signal is transmitted to the plurality of ranging signal generating devices 107a, 107b and 107c, while the content audio signal is transmitted to the plurality of speakers 101a, 101b and 101c.

In S203, after a preset time period from receipt of the synchronization signal, each of the plurality of ranging signal generating devices 107a, 107b and 107c generating a ranging sound signal at a time point.

In some embodiments, the preset time period for each of the plurality of ranging signal generating devices 107a, 107b and 107c is configured to be the same. That is, each of the plurality of ranging signal generating devices 107a, 107b and 107c may generate the ranging sound signal at a same time point. In this case, the ranging sound signals generated by the plurality of ranging signal generating devices 107a, 107b and 107c should be distinct from each other so that they can be distinguished in the records.

In some embodiments, the preset time period for each of the plurality of ranging signal generating devices 107a, 107b and 107c is configured to be different from others, such that the plurality of ranging signal generating devices 107a, 107b and 107c are configured to generate the ranging sound signals at different time points. It could be understood that, as long as the intervals between the time points when the ranging sound signals are generated are long enough, the ranging sound signals are able to be identified in the records.

In some embodiments, the receipt of the synchronization signal may be detected by a detecting unit, where the detecting unit is adapted to obtain a receipt time point of the synchronization signal being received by the plurality of ranging signal generating devices 107a, 107b and 107c. Each of the plurality of ranging signal generating devices may generate the ranging sound signal after the preset time period from the receipt time point. In some embodiments, the detecting unit may be a correlator which is adapted to obtain the receipt time point through cross-correlation.

It should be noted that, the ranging sound signals generated by the plurality of ranging signal generating devices 107a, 107b and 107c are electric signals, such as digital signals or analog signals. Thus, the ranging sound signals needs to be converted into acoustic signals before being broadcasted to the mobile device 20.

In some embodiments, the plurality of ranging signal generating devices 107a, 107b and 107c may be respectively connected to the plurality of speakers 101a, 101b and 101c. Thus, ranging sound signals generated by the plurality of ranging signal generating devices 107a, 107b and 107c are able to be respectively transmitted to the plurality of speakers 101a, 101b and 101c and be converted into an acoustic signal by the corresponding speaker. For example, the ranging signal generating device 107a is connected to the speaker 101a, the ranging signal generating device 107b is connected to the speaker 101b, and the ranging signal generating device 107c is connected to the speaker 101c. Thus, ranging sound signal generated by the ranging signal generating device 107a is able to be converted into an acoustic signal by the speaker 101a, ranging sound signal generated by the ranging signal generating device 107b is able to be converted into an acoustic signal by the speaker 101b, and ranging sound signal generated by the ranging signal generating device 107c is able to be converted into an acoustic signal by the speaker 101c.

In some embodiments, each of the plurality of ranging signal generating devices 107a, 107b and 107c may include a converting unit, such as an acoustic transducer, for converting the ranging sound signal into an acoustic signal, such that the ranging sound signals generated by the plurality ranging signal generating devices 107a, 107b and 107c are respectively reproduced by corresponding converting units. In this situation, the ranging sound signals don't need to be reproduced by the speakers.

In some embodiments, before the ranging sound signal is transmitted to one of the plurality of speakers or the acoustic transducers contained in the ranging signal generating devices 107a, 107b and 107c, the ranging sound signal produced by the ranging signal generating devices need to be amplified. Further, if the ranging sound signal is digital, it need further to be converted from a digital signal to an analog signal before amplified.

In S205, recording, by the mobile device 20, the ranging sound signals generated by the plurality of ranging signal generating devices 107a, 107b and 107c.

In some embodiments, recording the ranging sound signals may include: recording an arrival time of each ranging sound signal, recording an arrival time difference between each two ranging sound signals, or recording an attenuation of each ranging sound signal. Accordingly, distances between the mobile device 20 and each of the plurality of ranging signal generating devices 107 can be obtained.

In S207, calculating a location of the mobile device 20 based on the records of the ranging sound signals made by the mobile device 20.

The location of the mobile device 20 can be obtained by existing ways, such as Time of Arrival (TOA) Geolocation, Time Difference of Arrival (TDOA) Geolocation, and so on.

It should be noted that, when converting units are configured to convert the electric signals into the acoustic signals, the location of the mobile device 20 is obtained based on the records of the ranging sound signals and positions of the converting units because it is the converting units broadcasting the ranging sound signals. When the plurality of speakers 101a, 101b, and 101c are configured to convert the electric signals into the acoustic signals, the location of the mobile device 20 is obtained based on the records of the ranging sound signals and positions of the plurality of speakers 101a, 101b and 101c.

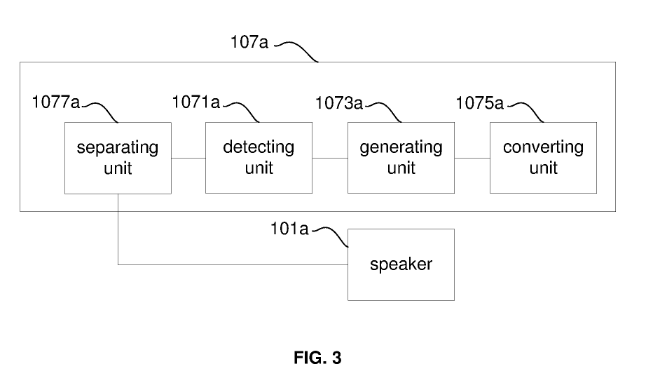

FIG. 3 schematically illustrates a diagram of the ranging signal generating device 107a. The ranging signal generating device 107a may include: a detecting unit 1071a, and a generating unit 1073a.

The detecting unit 1071a may be connected to the audio signal cable 103 for detecting if the amplified audio signal transmitted on the audio signal cable 103 contains a synchronization signal. The detecting unit 1071a may be further configured to detect a receipt time point of the synchronization signal being received by the ranging signal generating device 107a.

In some embodiments, the detecting unit 1071a may be a correlator for detecting the synchronization signal through cross-relation.

It should be noted that, in some embodiments, the plurality of ranging signal generating devices 107a, 107b and 107c may use a common detecting unit 1071a to detect the receipt of the synchronization signal.

The generating unit 1073a is configured to generate a ranging sound signal when the synchronization signal is detected by the detecting unit 1071a, where the ranging sound signal is generated at a time point after a preset time period from the synchronization signal is detected or from the receipt time point.

In some embodiments, the ranging signal generating device 107a may further include a converting unit 1075a. The converting unit 1075a is configured to convert electric signals from the generating unit 1073a into acoustic signals.

In some embodiments, the generating unit 1073a of the ranging signal generating device 107a may be connected to the speaker 101a, such that the electric signals from the generating unit 1073a is able to be converted into the acoustic signals by the speaker 101a. It should be noted that, in some embodiments, a digital to analog converter may be employed to convert the ranging sound signal from a digital signal to an analog signal before the ranging sound signal is transmitted to the speaker 101a. In some embodiments, an amplifier may be employed to amplify the ranging sound signal before transmitted to the speaker.

In some embodiments, the detecting unit 1071a of the ranging signal generating device 107a may be connected with a separating unit 1077a and receive the amplified audio signal from the separating unit 1077a. The separating unit 1077a is configured to separate the synchronization signal from the content audio signal, where the synchronization signal is transmitted to the plurality of ranging signal generating devices 107a, 107b and 107c, the content audio signal is transmitted to the plurality of speakers 101a, 101b and 101c for driving the plurality of speakers 101a, 101b and 101c to reproduce the content audio signal. In such way, accuracy rate and efficiency of the detecting unit 1071a may be improved.

In some embodiments, the synchronization signal may be a chirp signal and have a frequency higher than a preset value F1, the content audio signal may have a frequency lower than the preset value F1. The separating unit 1077a may include a high-pass filter for filtering out the content audio signal and pass the synchronization signal to be transmitted to the detecting unit 1071a of the ranging signal generating device 107a. The separating unit 1077a may further include a low-pass filter for filtering out synchronization signal and pass the content audio signal to be transmitted to the speaker 101a.

There is little distinction left between hardware and software implementations of aspects of systems; the use of hardware or software is generally a design choice representing cost vs. efficiency tradeoffs. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for generating a plurality of ranging audio signals for positioning a mobile device, comprising:
for each of a plurality of ranging signal generating devices that are connected to an audio signal cable and are located at different positions in an area, generating a ranging sound signal based on a synchronization signal transmitted on the audio signal cable, wherein a location of the mobile device within the area is obtained based on records of the ranging sound signals made by the mobile device.

2. The method according to claim 1, wherein the ranging sound signal is generated after a preset time period from when of the synchronization signal has been detected by a detecting unit, wherein the detecting unit is adapted to obtain a receipt time point of when the synchronization signal is received by the plurality of ranging signal generating devices.

3. The method according to claim 2, wherein the preset time period for each of the plurality of ranging signal generating devices is configured to be different, such that the ranging sound signals are generated at different time points.

4. The method according to claim 2, wherein the preset time period for each of the plurality of ranging signal generating devices is configured to be the same, wherein the ranging sound signals are distinct from each other.

5. The method according to claim 1, wherein the synchronization signal is mixed, by a mixing device, with a content audio signal that is to be transmitted on the audio signal cable, wherein the content audio signal is drives a plurality of speakers connected to the audio signal cable to reproduce the content audio signal.

6. The method according to claim 5, further comprising separating the synchronization signal and the content audio signal from each other, wherein the synchronization signal is transmitted to the plurality of ranging signal generating devices, and the content audio signal is transmitted to the plurality of speakers.

7. The method according to claim 1, wherein the plurality of ranging signal generating devices are respectively connected to a plurality of speakers, such that electric signals from the plurality of ranging signal generating devices are respectively converted into acoustic signals by the plurality of speakers.

8. The method according to claim 7, wherein each ranging sound signal is converted from a digital signal to an analog signal before the ranging sound signal is transmitted to one of the plurality of speakers.

9. The method according to claim 1, wherein the records of the ranging sound signals comprise at least one of an arrival time of each ranging sound signal, an arrival time difference between each of two ranging sound signals, and a signal attenuation of each ranging sound signal.

10. A system for generating a plurality of ranging sound signals for positioning a mobile device, comprising:
a plurality of ranging signal generating devices that are connected to an audio signal cable and are located at different positions in an area, wherein each of the plurality of ranging signal generating devices is configured to:
generate a ranging sound signal based on a synchronization signal transmitted on the audio signal cable, wherein a location of the mobile device within the area is obtained based on records of the ranging sound signals made by the mobile device.

11. The system according to claim 10, wherein the plurality of ranging signal generating devices are respectively connected to the plurality of speakers, such that electric signals from the plurality of ranging signal generating devices are respectively converted into acoustic signals by the plurality of speakers.

12. The system according to claim 10, further comprises a detecting unit adapted to detect when the synchronization signal is received, wherein the detecting unit is adapted to obtain a receipt time point of when the synchronization signal is received by the plurality of ranging signal generating devices.

13. The system according to claim 12, wherein the ranging sound signal is generated after a preset time period from when the synchronization signal is received.

14. The system according to claim 13, wherein the preset time period for each of the plurality of ranging signal generating devices is configured to be different, such that the ranging sound signals are generated at different time points.

15. The system according to claim 13, wherein the preset time period for each of the plurality of ranging signal generating devices is configured to be the same, wherein the ranging sound signals are distinct from each other.

16. The system according to claim 10, further comprises a mixing device for mixing the synchronization signal with a content audio signal before the mixed signal is transmitted on the audio signal cable, wherein the content audio signal drives a plurality of speakers connected to the audio signal cable to reproduce the content audio signal.

17. The system according to claim 16, further comprising a separating unit for separating the synchronization signal and the content audio signal from each other, where the synchronization signal is transmitted to the plurality of ranging signal generating devices, and the content audio signal is transmitted to the plurality of speakers.

18. The system according to claim 10, further comprises a digital to analog converter adapted to convert each ranging sound signal from a digital signal to an analog signal before the ranging sound signal is transmitted to one of the plurality of speakers.

19. The system according to claim 10, wherein the records of the ranging sound signals comprise at least one of an arrival time of each ranging sound signal, an arrival time difference between each of two ranging sound signals, and a signal attenuation of each ranging sound signal.
